(19) United States
(12) Patent Application Publication
(10) Pub. No.: US 2025/0318625 A1
(43) Pub. Date: Oct. 16, 2025

(54) SEALING LID ASSEMBLY AND PACKAGING CONTAINER USING SAME

(71) Applicant: SHYA HSIN PACKAGING INDUSTRY (CHINA) CO., LTD., Kunshan (CN)

(72) Inventor: Haiying YANG, Kunshan (CN)

(73) Assignee: SHYA HSIN PACKAGING INDUSTRY (CHINA) CO., LTD., Kunshan (CN)

(21) Appl. No.: 18/866,058

(22) PCT Filed: Mar. 15, 2023
(86) PCT No.: PCT/CN2023/081521

§ 371 Date: Nov. 14, 2024

(30) Foreign Application Priority Data
May 25, 2022 (CN) 202210575941.2

(51) Int. Cl. A45D 33/16

(52) U.S. Cl. CPC A45D 33/16

(57) ABSTRACT

A sealing lid assembly and a packaging container using the sealing lid assembly are provided. The sealing lid assembly includes an inner stopper, an inner lid, and a sealing member, where a discharge region is formed in the inner stopper; a discharge hole is formed in the discharge region; a discharge groove and a sealing region are formed in the inner lid; the sealing member is airtightly combined with the inner lid; the inner lid is rotatably connected to the inner stopper through a rotary mechanism; the inner lid is made of first plastic; the sealing member is made of second plastic; the inner lid and the sealing member are formed integrally through two-shot injection molding; and hardness of the first plastic is greater than hardness of the second plastic. Since the sealing member is airtightly combined with the inner lid, the sealing lid assembly has a desirable sealing effect.

### CROSS REFERENCE TO THE RELATED APPLICATIONS

This application is the national phase entry of International Application No. PCT/CN2023/081521, filed on Mar. 15, 2023, which is based upon and claims priority to Chinese Patent Application No. 202210575941.2, filed on May 25, 2022, the entire contents of which are incorporated herein by reference.

### TECHNICAL FIELD

The present application relates to the field of cosmetic packaging, and in particular to a sealing lid assembly and a packaging container using the sealing lid assembly.

### BACKGROUND

An existing loose powder case usually includes a body, an inner sleeve, and a lid. A separation plate is provided on the body. A separation plate powder outlet is formed in the separation plate. An inner-sleeve powder outlet is formed in the inner sleeve. The inner sleeve is provided in the body. The lid covers the body. By rotating the inner sleeve, the inner-sleeve powder outlet communicates with the separation plate powder outlet, such that powder in the body is discharged conveniently, or the separation plate powder outlet is sealed by the inner sleeve, such that the powder in the body cannot be discharged. Before first use, a tear-away lid is provided in the inner-sleeve powder outlet. However, before the first use of the loose powder case, due to a gap between the tear-away lid and the inner sleeve, outside air comes into the body easily through the gap, thereby affecting the quality of the loose powder and shortening the storage life of the loose powder.

### SUMMARY

In order to overcome the above defects, the present application provides a sealing lid assembly. According to the sealing lid assembly, the discharge groove is formed in the inner lid, and the periphery of the sealing member is airtightly connected to the inner lid together to seal the discharge groove. Therefore, outside air cannot come into loose powder in the packaging container through the sealing lid assembly, thereby ensuring the quality of the loose powder and prolonging the storage life of the loose powder.

To solve the technical problems, the present application adopts the following technical solutions:

The present application provides a sealing lid assembly, including an inner stopper, an inner lid, and a sealing member, where a discharge region is formed in the inner stopper; a discharge hole is formed in the discharge region; a discharge groove and a sealing region are formed in the inner lid; the sealing member is airtightly combined with the inner lid; the sealing member is configured to seal the discharge groove; the sealing member is configure to be torn down from the inner lid to expose the discharge groove; the inner lid is rotatably connected to the inner stopper through a rotary mechanism; the inner lid is made of first plastic; the sealing member is made of second plastic; the inner lid and the sealing member are formed integrally through two-shot injection molding; and hardness of the first plastic is greater than hardness of the second plastic.

Optionally, a limit mechanism is provided between the inner stopper and the inner lid; when the inner lid is rotated relative to the inner stopper, the limit mechanism is configured to limit the inner lid at a first position and a second position of the inner stopper; when the inner lid is located at the first position of the inner stopper, the discharge groove is located on the discharge region and communicates with the discharge hole, and the sealing member covers the discharge region; and when the inner lid is located at the second position of the inner stopper, the sealing region covers the discharge region to seal the discharge hole.

Optionally, a puller is fixedly provided on an upper surface of the sealing member; a downwardly extending protrusion is provided on a lower surface of the sealing member; and the protrusion is configured to be inserted into the discharge hole to seal the discharge hole.

Optionally, the inner stopper includes a first bottom disc and a circle of first sidewall extending along an axial direction at a periphery of the first bottom disc; and the inner lid includes a second bottom disc and a circle of second sidewall extending along the axial direction at a periphery of the second bottom disc.

Optionally, each of the first bottom disc and the second bottom disc is a circular structure; a diameter of the first bottom disc is greater than a diameter of the second bottom disc; the discharge region is located on the first bottom disc; and the sealing region, the discharge groove and the sealing member are located on the second bottom disc.

Optionally, the rotary mechanism includes a rotation hole and a rotating shaft; the rotation hole is formed at a central position of the first bottom disc, and the rotating shaft is provided at a central position of the second bottom disc; or the rotation hole is formed at the central position of the second bottom disc, and the rotating shaft is provided at the central position of the first bottom disc; and the rotating shaft is inserted into the rotation hole during assembly.

Optionally, the limit mechanism includes a guide post and a guide groove; during assembly, the guide post is provided in the guide groove and the guide post is configure to slide in the guide groove; the guide post is provided on the first bottom disc, and the guide groove is formed in the second bottom disc; or the guide post is provided on the second bottom disc, and the guide groove is formed in the first bottom disc; and the guide groove is a circular arc-shaped structure, and the guide groove is coaxial with the first bottom disc or the second bottom disc.

Optionally, the limit mechanism includes a guide post and a guide groove; during assembly, the guide post is provided in the guide groove and the guide post is configure to slide in the guide groove; the guide post is provided on the first sidewall, and the guide groove is formed in the second sidewall; or the guide post is provided on the second sidewall, and the guide groove is formed in the first sidewall; and the guide groove is a circular arc-shaped structure, and the guide groove is coaxial with the first bottom disc or the second bottom disc.

The present application further provides a packaging container, where the packaging container includes the sealing lid assembly.

Optionally, the packaging container further includes a case, an outer lid, a powder puff, and a gasket; the inner stopper is fixedly provided in the case; the outer lid is detachably covered onto the case; the sealing lid assembly is located in the case and the outer lid; the powder puff is provided in the inner lid; and the gasket is attached to an inner surface of the outer lid.

The present application has the following beneficial effects: According to the present application, the sealing lid assembly includes an inner stopper, an inner lid, and a sealing member. The inner lid is rotatably provided in the inner stopper. The inner lid is formed integrally with the sealing member through two-shot injection molding. A periphery of the sealing member is connected to the inner stopper together to seal the discharge groove. That is, the sealing member is airtightly connected to the inner lid. Before first use, the inner stopper is sealed by the inner lid having the sealing member. Hence, outside air comes into neither the packaging container having the sealing lid assembly, nor the loose powder in the packaging container, through the sealing lid assembly. This ensures that the quality of the loose powder cannot be deteriorated for oxidation or moisture absorption, prolongs the storage life of the loose powder, and ensures that the loose powder is not scattered through the sealing lid assembly to cause waste and pollution.

### BRIEF DESCRIPTION OF THE DRAWINGS

FIG. 1 is a sectional view of a sealing lid assembly according to Embodiment 1;

FIG. 2 is a side view of a sealing lid assembly according to Embodiment 1;

FIG. 3 is a top view of a sealing lid assembly according to Embodiment 1;

FIG. 4 is a schematic structural view of an inner stopper according to Embodiment 1;

FIG. 5 is a schematic structural view of an inner lid according to Embodiment 1;

FIG. 6 is a side view of an inner lid according to Embodiment 1;

FIG. 7 is a top view of an inner lid according to Embodiment 1;

FIG. 8 is a sectional view of an inner lid according to Embodiment 1;

FIG. 9 is a sectional view of a packaging container according to Embodiment 1;

FIG. 10 is an exploded view of a packaging container according to Embodiment 1;

FIG. 11 is a sectional view of a sealing lid assembly according to Embodiment 2;

FIG. 12 is a side view of a sealing lid assembly according to Embodiment 2;

FIG. 13 is a top view of a sealing lid assembly according to Embodiment 2;

FIG. 14 is a schematic structural view of an inner stopper according to Embodiment 2;

FIG. 15 is a schematic structural view of an inner lid according to Embodiment 2;

FIG. 16 is a side view of an inner lid according to Embodiment 2;

FIG. 17 is a top view of an inner lid according to Embodiment 2;

FIG. 18 is a sectional view of an inner lid according to Embodiment 2;

FIG. 19 is a sectional view of a packaging container according to Embodiment 2; and

FIG. 20 is an exploded view of a packaging container according to Embodiment 2.

In the figures: 10—inner stopper, 11—first bottom disc, 12—first sidewall, 13—discharge region, 14—discharge hole, 15—rotation hole, 16—guide post, 20—inner lid, 21—second bottom disc, 22—second sidewall, 23—sealing region, 24—guide groove, 25—sealing member, 26—puller, 27—protrusion, 28—rotating shaft, 30—case, 40—outer lid, 50—powder puff, and 60—gasket.

### DETAILED DESCRIPTION OF THE EMBODIMENTS

The technical solutions in the embodiments of the present application are clearly and completely described below with reference to the embodiments of the present application. Apparently, the described embodiments are merely some rather than all of the embodiments of the present application. All other embodiments obtained by a person of ordinary skill in the art based on the embodiments of the present application without creative efforts shall fall within the protection scope of the present application.

It should be noted that the terms “first”, “second”, and so on in the description and claims of this application and in the above accompanying drawings are intended to distinguish similar objects but do not necessarily indicate a specific order or sequence. It should be understood that the data used in such a way may be exchanged under proper conditions to make it possible to implement the described implementations of this application in sequences except those illustrated or described herein. Moreover, the terms “include”, “contain”, and any other variants mean to cover the non-exclusive inclusion, for example, a process, method, system, product, or device that includes a list of steps or units is not necessarily limited to those steps or units which are clearly listed, but may include other steps or units which are not expressly listed or inherent to such a process, method, system, product, or device.

For ease of description, spatially relative terms, such as “above”, “on the upper side of”, “on the upper surface of” and “on”, can be used to describe the spatial positional relationship between components or features shown in the figure. It should be understood that the spatially relative terms are intended to encompass different orientations of the components in use or operation in addition to those shown in the figure. For example, if a component in the figure is inverted, it is described as a component “above other component or structure” or “on other component or structure”. Therefore, the component will be positioned as “below other component or structure” or “under other component or structure”. Therefore, the exemplary term “above” may include both orientations “above” and “below”. The component may also be positioned in other different ways (rotated by 90 degrees or in other orientations), but the relative description of the space should be explained accordingly.

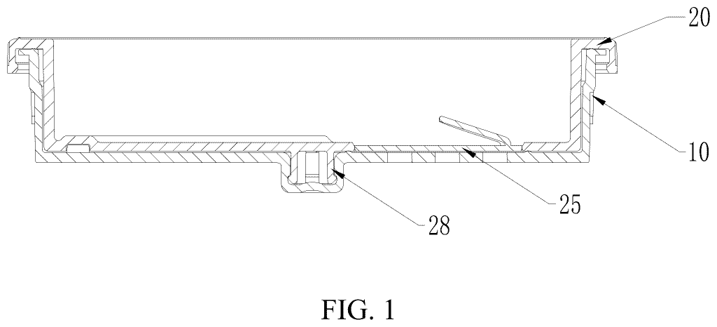

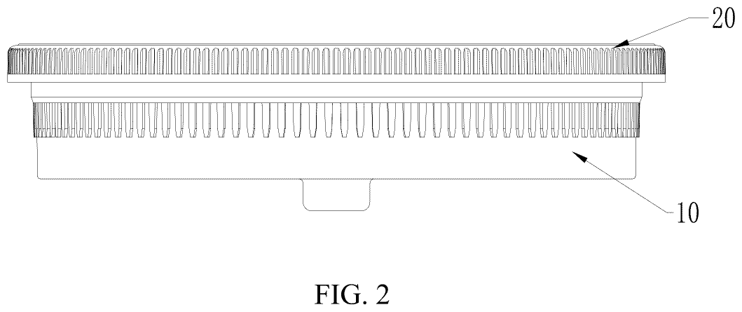

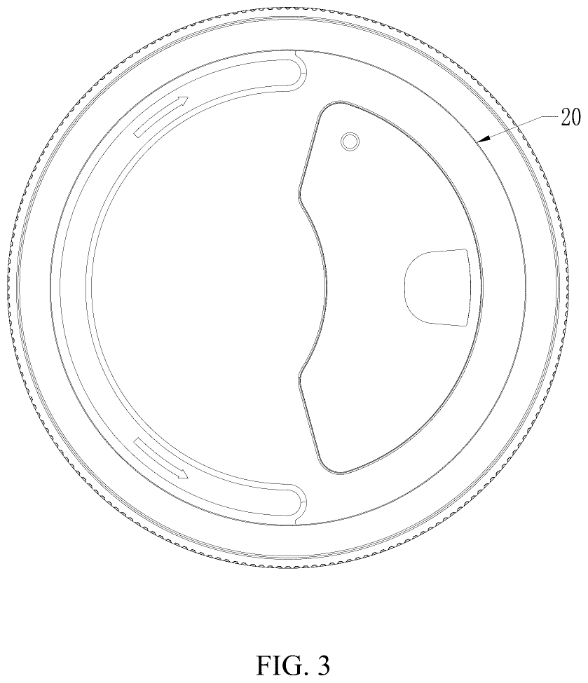

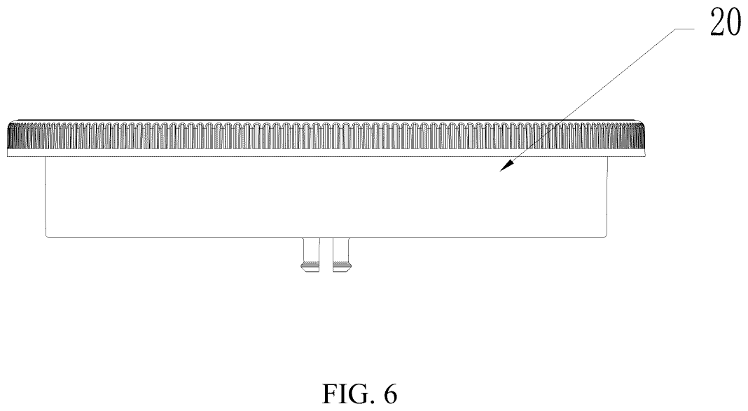

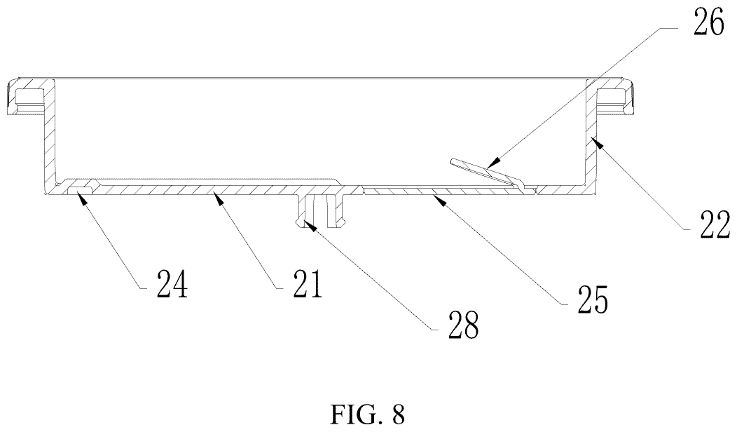

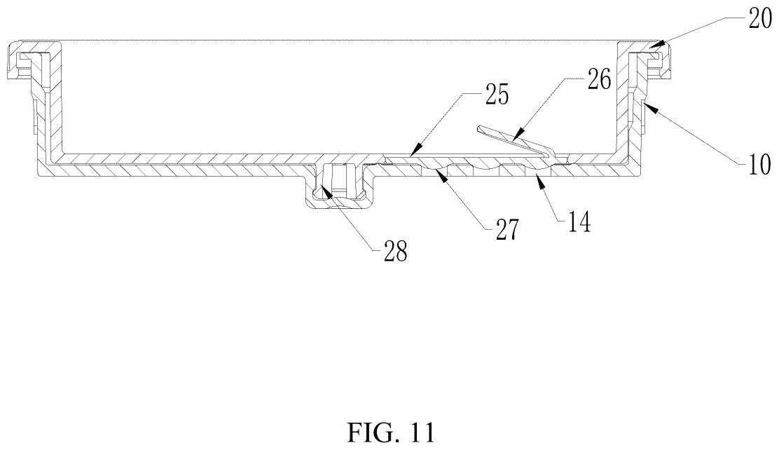

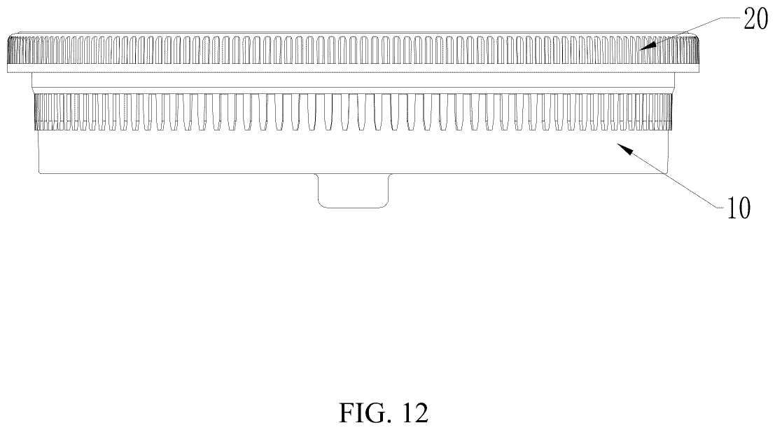

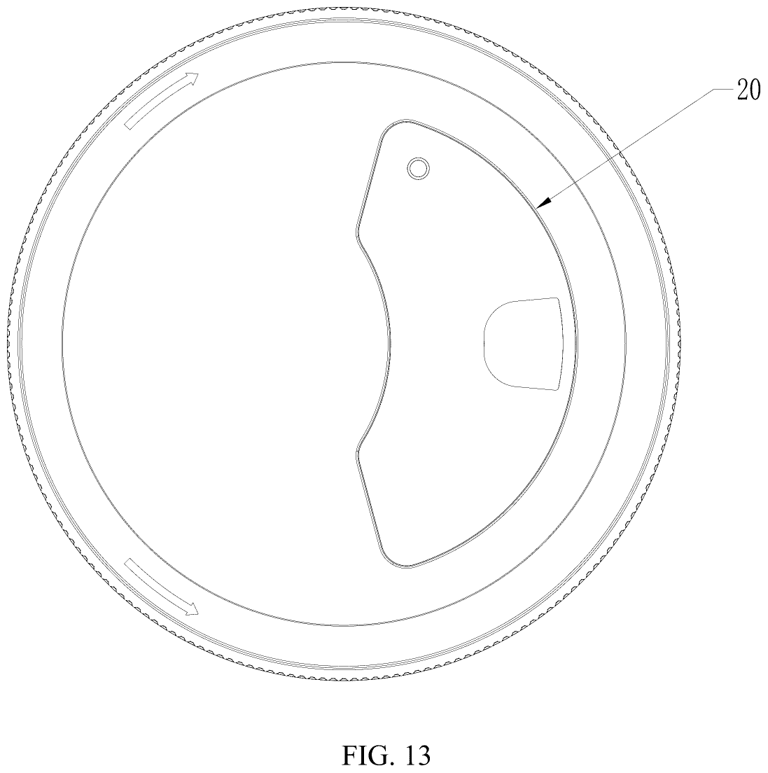

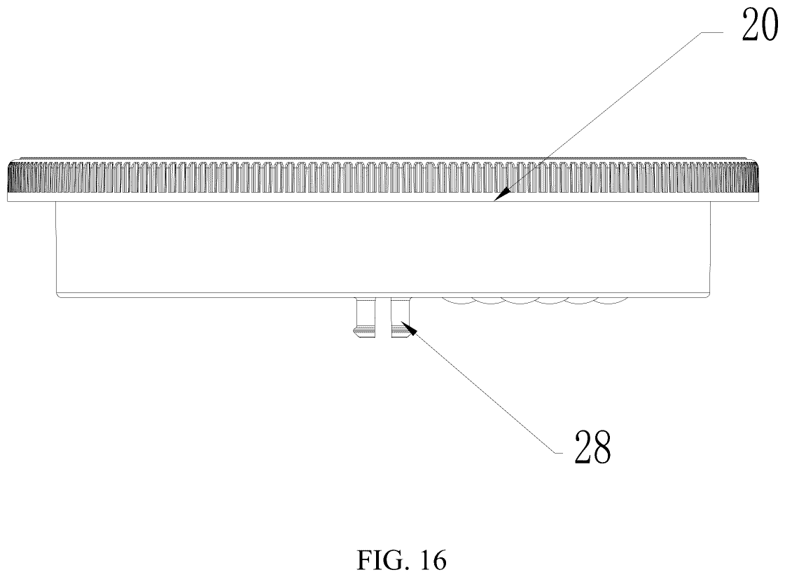

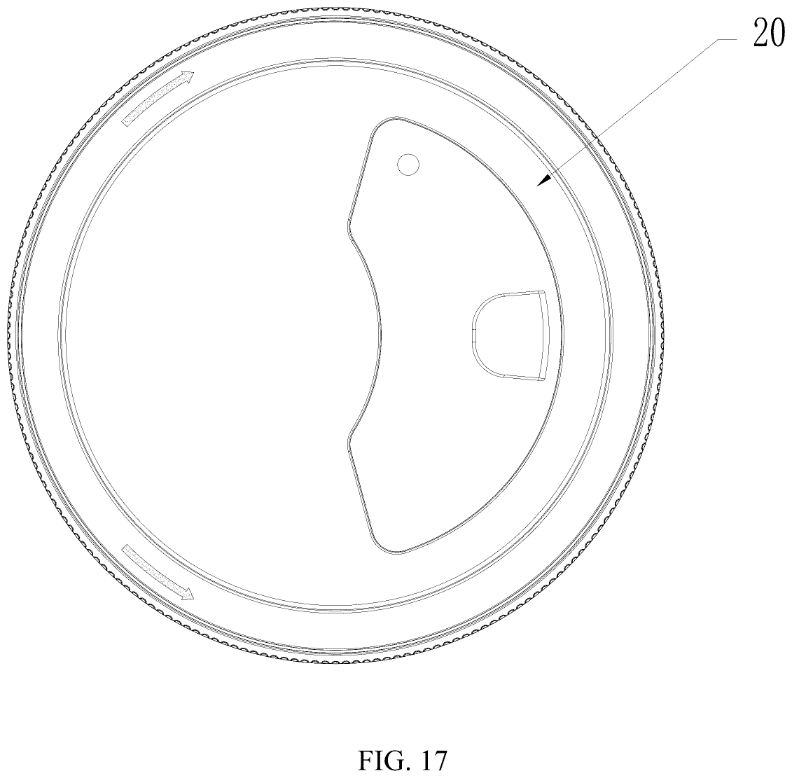

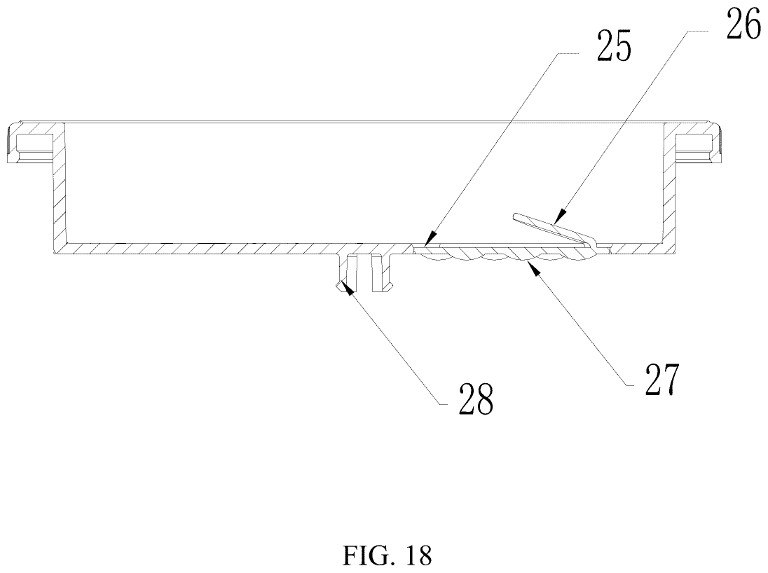

As shown in FIG. 1 to FIG. 20, a sealing lid assembly includes inner stopper 10, inner lid 20, and sealing member 25. Discharge region 13 is formed in the inner stopper 10. A plurality of discharge holes 14 are formed in the discharge region 13. A discharge groove and sealing region 23 are formed in the inner lid 20. The sealing member 25 is airtightly combined with the inner lid 20. The sealing member 25 is configured to seal the discharge groove. The sealing member 25 can be torn down from the inner lid 20 to expose the discharge groove. The inner lid 20 is rotatably connected to the inner stopper 10 through a rotary mechanism. The conventional sealing member is connected to the inner lid through ribs, so there is a gap between the sealing member and the inner lid. Before first use of the loose powder case, outside air comes into powder easily through the gap, thereby affecting the quality of the loose powder and shortening the storage life of the loose powder. Unlike the conventional technical solutions, according to the present application, the periphery of the sealing member 25 is connected to the inner stopper 20 together to seal the discharge groove. That is, the sealing member 25 is airtightly connected to the inner lid 20. Before first use, the inner stopper 10 is sealed by the inner lid having the sealing member. Hence, outside air comes into neither the packaging container having the sealing lid assembly, nor the loose powder in the packaging container, through the sealing lid assembly. This ensures that the quality of the loose powder cannot be deteriorated for oxidation or moisture absorption, prolongs the storage life of the loose powder, and ensures that the loose powder is not scattered through the sealing lid assembly to cause waste and pollution.

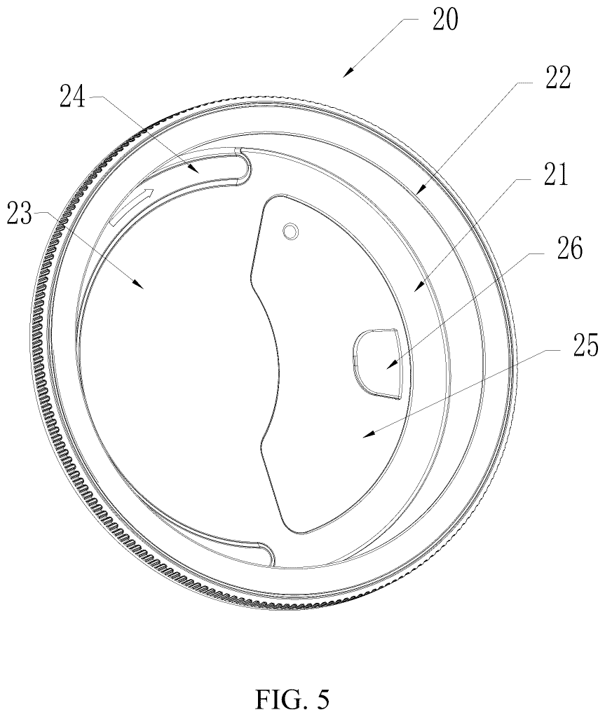

As shown in FIG. 5 to FIG. 8, the inner lid 20 is made of first plastic. The sealing member 25 is made of second plastic. The inner lid 20 and the sealing member 25 are formed integrally through two-shot injection molding. Hardness of the first plastic is greater than hardness of the second plastic. Both the inner lid 20 and the sealing member 25 are made of plastic, and hardness of the inner lid 20 is greater than hardness of the sealing member 25, so the sealing member is torn down from the inner lid conveniently. The sealing member 25 is configured to seal the packaging container from delivery to first use of the sealing lid assembly. In the first use, the sealing member 25 is torn down and abandoned to expose the discharge groove in the inner lid 20. Hence, the cosmetic material can be discharged through the discharge hole 14 and the discharge groove to meet use requirements of the user. The inner lid and the sealing member are formed through the two-shot injection molding, and the periphery of the sealing member is airtightly connected to the inner lid 20. Therefore, the present application has a desirable sealing effect, and can isolate the loose powder in the packaging container completely from the outside air.

Optionally, a limit mechanism is provided between the inner stopper 10 and the inner lid 20. When the inner lid 20 is rotated relative to the inner stopper 10, the limit mechanism is configured to limit the inner lid 20 at a first position and a second position of the inner stopper 10. When the inner lid 20 is located at the first position of the inner stopper 10, the discharge groove is located on the discharge region 13 and communicates with the discharge hole 14, and the sealing member 25 covers the discharge region 13. When the inner lid 20 is located at the second position of the inner stopper 10, the sealing region 23 covers the discharge region 13 to seal the discharge hole 14.

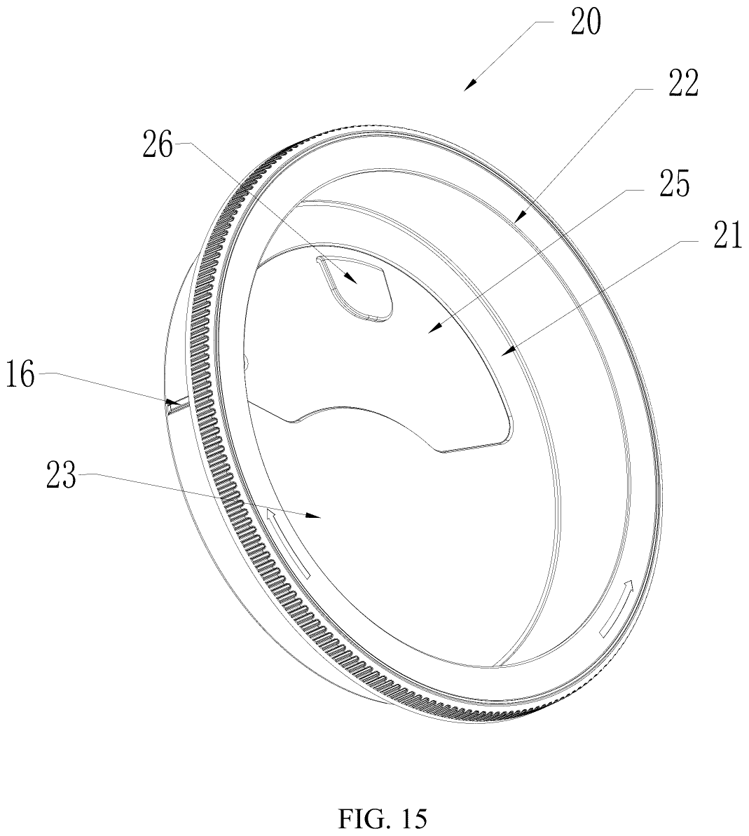

As shown in FIG. 15 to FIG. 18, puller 26 is fixedly provided on an upper surface of the sealing member 25. A plurality of downwardly extending protrusions 27 are provided on a lower surface of the sealing member 25. The protrusions 27 each are configured to be inserted into the discharge hole 14 to seal the discharge hole 14. The sealing member 25 can be torn down conveniently through the puller 26. In storage, the protrusion 27 on the sealing member 25 blocks off the discharge hole 14 in the inner stopper, thereby further improving the sealing effect of the discharge hole.

As shown in FIG. 1 to FIG. 5 or FIG. 11 to FIG. 15, the inner stopper 10 includes first bottom disc 11 and a circle of first sidewall 12 extending along an axial direction at a periphery of the first bottom disc 11. The inner lid 20 includes second bottom disc 21 and a circle of second sidewall 22 extending along the axial direction at a periphery of the second bottom disc 21. Each of the first bottom disc 11 and the second bottom disc 21 is a circular structure. A diameter of the first bottom disc 11 is greater than a diameter of the second bottom disc 21. The discharge region 13 is located on the first bottom disc 11. The sealing region 23, the discharge groove and the sealing member 25 are located on the second bottom disc 21.

Both the inner stopper 10 and the inner lid 20 are a circular cup-shaped structure. The inner lid 20 is provided in the inner stopper 10. The second bottom disc 21 is tightly attached to the first bottom disc 11. The second sidewall 22 is tightly attached to the first sidewall 12. A raised edge is provided at an upper end of the second sidewall 22. The raised edge covers an upper end of the first sidewall. The inner stopper 10 is rotatably connected to the inner lid 20. The fan-shaped discharge region 13 is formed in the inner stopper 10. A plurality of discharge holes 14 are formed in the discharge region 13. Correspondingly, the discharge groove matching with the discharge region 13 is formed in the inner lid 20. A portion other than the discharge groove in the inner lid is the sealing region 23. In use, after the sealing member 25 is torn down, by rotating the inner lid 20, the discharge groove in the inner lid is located fittingly on the discharge region 13 of the inner stopper, the discharge hole 14 communicates with the discharge groove, and the cosmetic material can be discharged through the discharge hole 14 and the discharge groove to meet the use requirement of the user. When the sealing lid assembly is not in use, by rotating the inner lid 20, the sealing region 23 in the inner lid seals the discharge region of the inner stopper completely to seal all discharge holes.

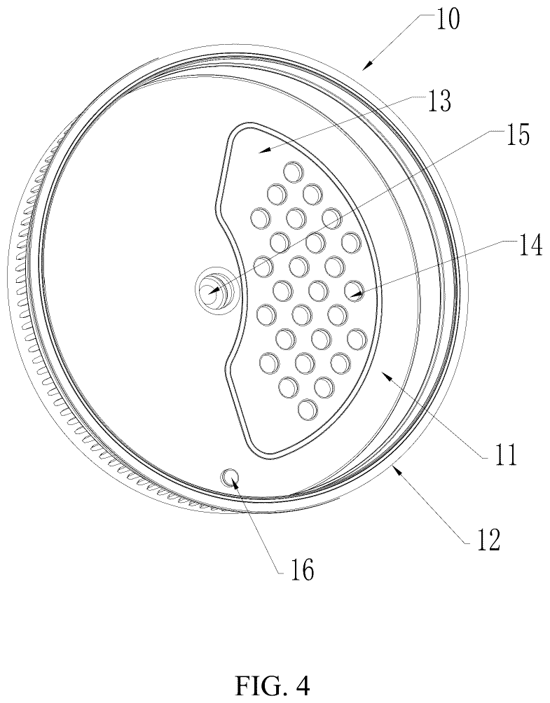

As shown in FIG. 1, FIG. 4 and FIG. 5, the rotary mechanism includes rotation hole 15 and rotating shaft 28. The rotation hole 15 is formed at a central position of the first bottom disc 11. The rotating shaft 28 is provided at a central position of the second bottom disc 21. Alternatively, the rotation hole 15 is formed at the central position of the second bottom disc 21. The rotating shaft 28 is provided at the central position of the first bottom disc 11. The rotating shaft 28 is inserted into the rotation hole 15 during assembly. The central position of the second bottom disc 21 extends downward along the axial direction to form the rotating shaft 28. Correspondingly, the rotation hole 15 is formed at the central position of the first bottom disc 11. The rotating shaft 28 is inserted into the rotation hole 15. Hence, the inner lid 20 rotates around the inner stopper 10, with the rotating shaft as a center, and the discharge groove or the sealing region 23 is located fittingly on the discharge region. Certainly, the rotating shaft 28 may also be provided on the first bottom disc 11, and the rotation hole 15 may also be formed in the second bottom disc 21. Optionally, the rotation hole is designed as a blind hole. This can effectively prevent the cosmetic material from entering the rotation hole and the rotating shaft, or the outside air from coming into the loose powder through the rotation hole.

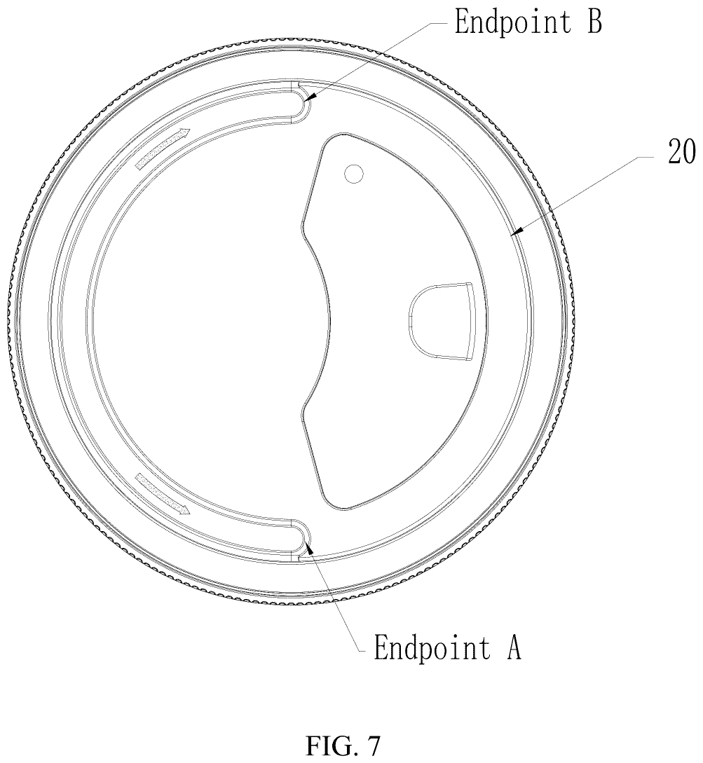

Embodiment 1: As shown in FIG. 4 to FIG. 5, and FIG. 7, the limit mechanism includes guide post 16 and guide groove 24. In assembling, the guide post 16 is provided in the guide groove 24 and the guide post 16 can slide in the guide groove 24. The guide post 16 is provided on the first bottom disc 11. The guide groove 24 is formed in the second bottom disc 21. Alternatively, the guide post 16 is provided on the second bottom disc 21. The guide groove 24 is formed in the first bottom disc 11. The guide groove 24 is a circular arc-shaped structure. The guide groove 24 is coaxial with the first bottom disc 11 or the second bottom disc 21. The guide post 16 is provided in a non-discharge region of the first bottom disc 11. The guide post extends toward an inner side of the inner stopper along an axial direction of the first bottom disc 11. The guide groove 24 is formed in the lower surface of the second bottom disc 21. The guide groove is formed in the sealing region 23. The guide groove is coaxial with the second bottom disc. Hence, when the inner lid rotates with the rotating shaft as the center, the guide post 16 is always located in the guide groove 24. Two ends of the guide groove 24 are respectively defined as endpoint A and endpoint B (as shown in FIG. 7). When the inner lid 20 rotates, the guide groove 24 moves back and forth along the guide post 16. The endpoint A and the endpoint B of the guide groove are two extreme positions of the guide post 16. When the inner lid rotates along a direction until the guide post 16 props against the endpoint A, namely the inner lid 20 is limited at the first position of the inner stopper 10, the inner lid 20 cannot rotate along the same direction. This is the same as the case where before the first use, the sealing member 25 covers the discharge region of the inner stopper, and the protrusion 27 on the sealing member is inserted into the discharge hole 14 to seal the discharge hole. If the sealing lid assembly has been used, namely the sealing member 25 has been torn down, the discharge groove of the inner lid is located in the discharge region 13 of the inner stopper, and the discharge hole 14 communicates with the discharge groove, such that the sealing lid assembly is in a usage state. When the inner lid rotates along a reverse direction until the guide post 16 abuts against the endpoint B, namely the inner lid 20 is limited at the second position of the inner stopper 10, the sealing region 23 of the inner lid covers the discharge region 13 of the inner stopper to seal all discharge holes 14, namely the sealing lid assembly is in a standby state. Certainly, the guide post 16 may also be provided on the lower surface of the second bottom disc 21, and the guide groove 24 may also be formed in the first bottom disc 11. The specific principle is the same as above, and is not repeated herein.

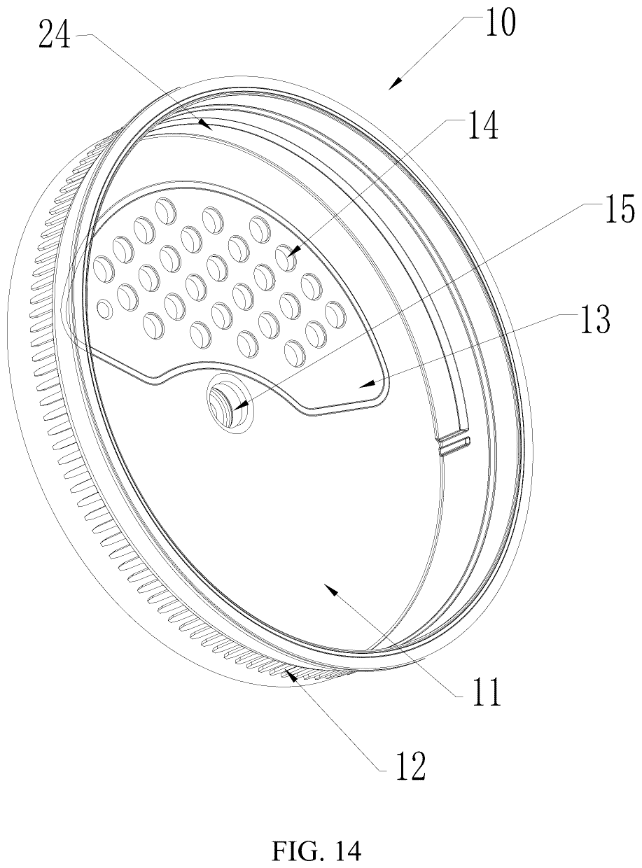

Embodiment 2: The embodiment differs from Embodiment 1 in the position of the guide post and the position of the guide groove. As shown in FIG. 14 to FIG. 15, the limit mechanism includes guide post 16 and guide groove 24. In assembling, the guide post 16 is provided in the guide groove 24 and the guide post 16 can slide in the guide groove 24. The guide post 16 is provided on the first sidewall 12. The guide groove 24 is formed in the second sidewall 22. Alternatively, the guide post 16 is provided on the second sidewall 22. The guide groove 24 is formed in the first sidewall 12. The guide groove 24 is a circular arc-shaped structure. The guide groove 24 is coaxial with the first bottom disc 11 or the second bottom disc 21. An outer side of the second sidewall 22 extends outwardly along a radial direction to form the guide post 16. The circular arc-shaped guide groove 24 is formed in an inner side of the first sidewall 12. The guide groove is coaxial with the first sidewall. In mounting, the guide post 16 is provided in the guide groove 24. When the inner lid is rotated, the guide post 16 moves in the guide groove 24. The specific movement is the same as that in Embodiment 1, and is not repeated herein. Likewise, the guide post 16 may also be provided on the second sidewall 22, and the guide groove 24 may also be formed in the first sidewall 12.

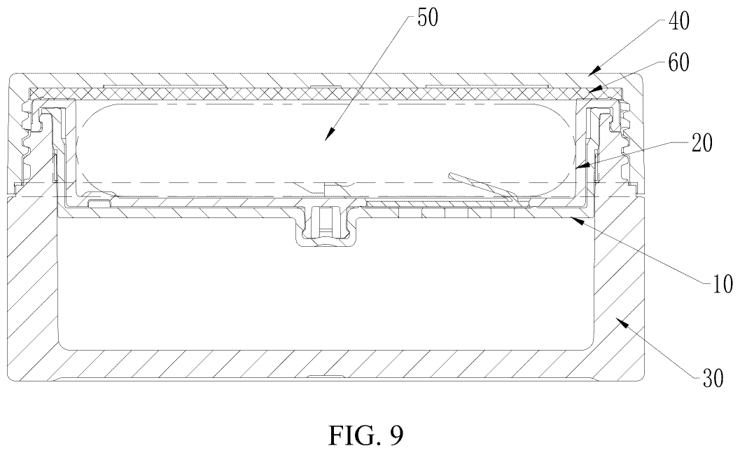

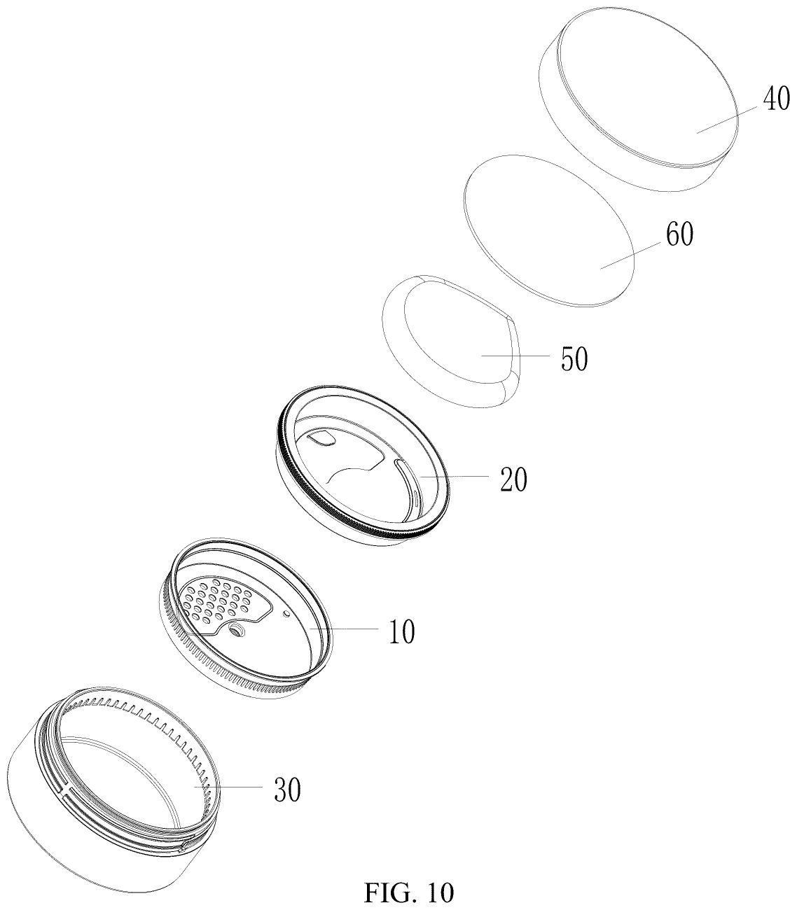

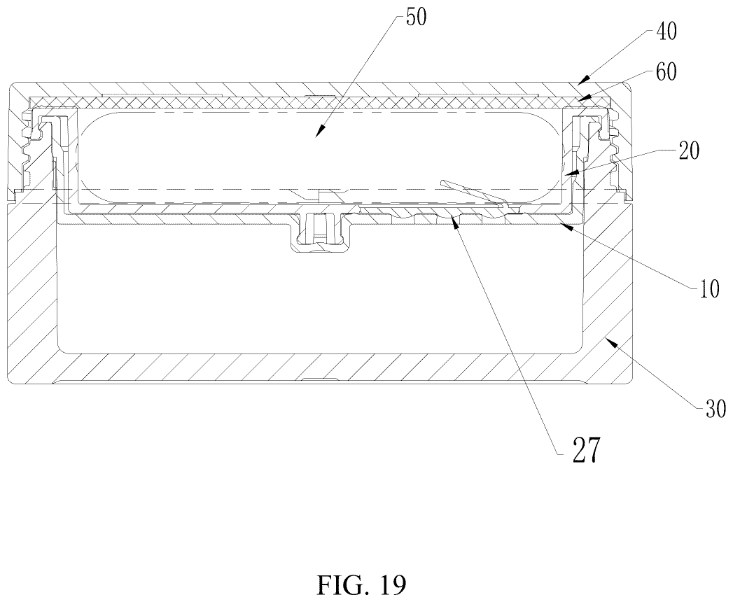

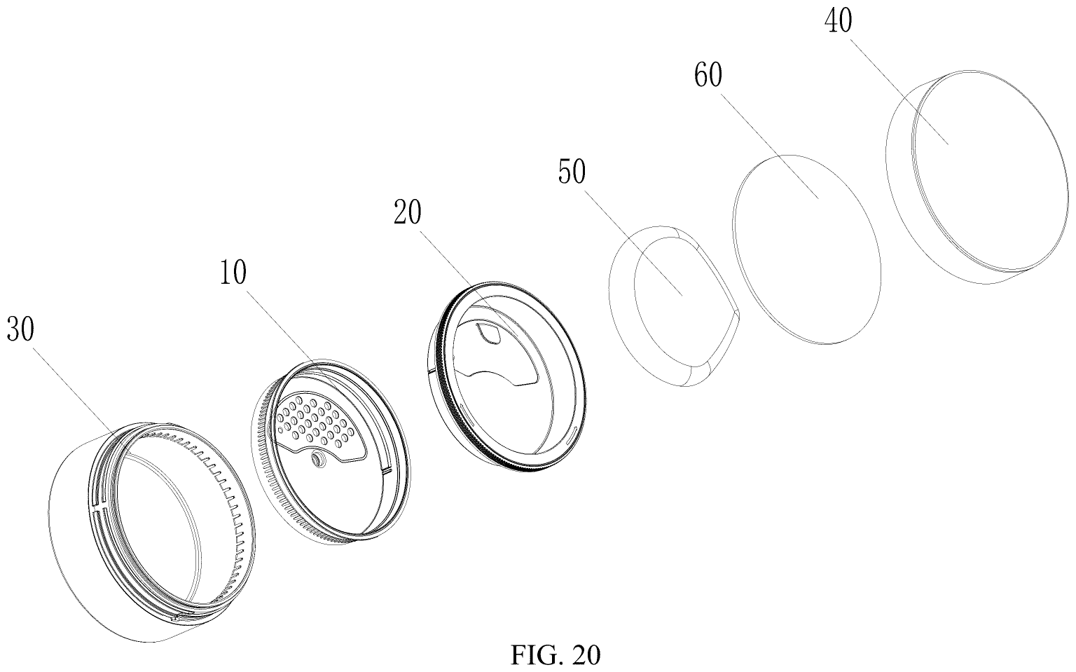

As shown in FIG. 9 to FIG. 10 and FIG. 19 to FIG. 20, a packaging container includes the sealing lid assembly, case 30, outer lid 40, powder puff 50, and gasket 60. The inner stopper 10 is fixedly provided in the case 30. The outer lid 40 is detachably covered onto the case 30. The sealing lid assembly is located in the case 30 and the outer lid 40. The powder puff 50 is provided in the inner lid 20. The gasket 60 is attached to an inner surface of the outer lid 40. As shown in FIG. 9 to FIG. 10, the packaging container uses the sealing lid assembly in Embodiment 1. As shown in FIG. 19 to FIG. 20, the packaging container uses the sealing lid assembly in Embodiment 2. The packaging container is sequentially provided with the outer lid 40, the gasket 60, the powder puff 50, the inner lid 20, the inner stopper 10, and the case 30 from top to bottom. Loose powder is stored in the case 30. The inner stopper 10 may be fixedly provided on an inner sidewall of an opening of the case 30 by clamping. The inner lid 20 is rotatably connected to the inner stopper 10, and configured to adjust a power outlet position or a sealing position of the inner stopper. The powder stopper 50 is provided in the inner lid 20, and configured to make up a user. The gasket 60 is provided at an inner side of the outer lid 40, and configured to further seal the inner lid 20. The outer lid 40 may be connected to the case 30 through a common threaded connection manner, a buckling manner or a magnetic manner.

The packaging container in the present application has the following operation process: With Embodiment 1 as an example for description, before first use, the sealing member 25 on the inner lid 20 is attached to the discharge region 13 of the inner stopper 10. The protrusion 27 on the sealing member is inserted into the discharge hole 14 to seal the discharge hole. The guide post 16 abuts against the endpoint A of the guide groove 24 (as shown in FIG. 7), namely the inner lid 20 is limited at the first position of the inner 10. In the first use, the outer lid 40 is opened. The powder puff 50 is taken out. The sealing member 25 is torn down through the puller 26 and abandoned to expose the discharge groove of the inner lid. The discharge groove communicates with the discharge hole 14. The powder in the case 30 is discharged through the discharge hole 14 and the discharge groove. The powder puff is used to take the powder for makeup. After the use, the inner lid 20 is rotated, until the guide post 16 on the inner lid abuts against the endpoint B of the guide groove 24 (as shown in FIG. 7), namely the inner lid 20 is limited at the second position of the inner stopper 10. The sealing region 23 of the inner lid covers the discharge region 13 of the inner stopper to seal all discharge holes 14, namely the sealing lid assembly is in the standby state.

It should be noted that those of ordinary skill in the art can further make variations and improvements without departing from the conception of the present application. These variations and improvements all fall within the protection scope of the present application. Therefore, the protection scope of the present application shall be subject to the appended claims.

What is claimed is:

1. A sealing lid assembly, comprising an inner stopper, an inner lid, and a sealing member, wherein a discharge region is formed in the inner stopper; a discharge hole is formed in the discharge region; a discharge groove and a sealing region are formed in the inner lid; the sealing member is airtightly combined with the inner lid; the sealing member is configured to seal the discharge groove; the sealing member is configure to be torn down from the inner lid to expose the discharge groove; the inner lid is rotatably connected to the inner stopper through a rotary mechanism; the inner lid is made of first plastic; the sealing member is made of second plastic; the inner lid and the sealing member are formed integrally through two-shot injection molding; and hardness of the first plastic is greater than hardness of the second plastic.

2. The sealing lid assembly according to claim 1, wherein a limit mechanism is provided between the inner stopper and the inner lid; when the inner lid is rotated relative to the inner stopper, the limit mechanism is configured to limit the inner lid at a first position and a second position of the inner stopper; when the inner lid is located at the first position of the inner stopper, the discharge groove is located on the discharge region and communicates with the discharge hole, and the sealing member covers the discharge region; and when the inner lid is located at the second position of the inner stopper, the sealing region covers the discharge region to seal the discharge hole.

3. The sealing lid assembly according to claim 2, wherein a puller is fixedly provided on an upper surface of the sealing member; protrusion is provided on a lower surface of the sealing member and extends downwardly; and the protrusion is configured to be inserted into the discharge hole to seal the discharge hole.

4. The sealing lid assembly according to claim 2, wherein the inner stopper comprises a first bottom disc and a circle of first sidewall extending along an axial direction at a periphery of the first bottom disc; and the inner lid comprises a second bottom disc and a circle of second sidewall extending along the axial direction at a periphery of the second bottom disc.

5. The sealing lid assembly according to claim 4, wherein each of the first bottom disc and the second bottom disc is a circular structure; a diameter of the first bottom disc is greater than a diameter of the second bottom disc; the discharge region is located on the first bottom disc; and the sealing region, the discharge groove and the sealing member are located on the second bottom disc.

6. The sealing lid assembly according to claim 4, wherein the rotary mechanism comprises a rotation hole and a rotating shaft; the rotation hole is formed at a central position of the first bottom disc, and the rotating shaft is provided at a central position of the second bottom disc; or the rotation hole is formed at the central position of the second bottom disc, and the rotating shaft is provided at the central position of the first bottom disc; and the rotating shaft is inserted into the rotation hole during assembly.

7. The sealing lid assembly according to claim 4, wherein the limit mechanism comprises a guide post and a guide groove; during assembly, the guide post is provided in the guide groove and the guide post is configure to slide in the guide groove; the guide post is provided on the first bottom disc, and the guide groove is formed in the second bottom disc; or the guide post is provided on the second bottom disc, and the guide groove is formed in the first bottom disc; and the guide groove is a circular arc-shaped structure, and the guide groove is coaxial with the first bottom disc or the second bottom disc.

8. The sealing lid assembly according to claim 4, wherein the limit mechanism comprises a guide post and a guide groove; during assembly, the guide post is provided in the guide groove and the guide post is configure to slide in the guide groove; the guide post is provided on the circle of first sidewall, and the guide groove is formed in the circle of second sidewall; or the guide post is provided on the circle of second sidewall, and the guide groove is formed in the circle of first sidewall; and the guide groove is a circular arc-shaped structure, and the guide groove is coaxial with the first bottom disc or the second bottom disc.

9. A packaging container, comprising the sealing lid assembly according to claim 1.

10. The packaging container according to claim 9, further comprising a case, an outer lid, a powder puff, and a gasket, wherein the inner stopper is fixedly provided in the case; the outer lid is detachably covered onto the case; the sealing lid assembly is located in the case and the outer lid; the powder puff is provided in the inner lid; and the gasket is attached to an inner surface of the outer lid.

11. The sealing lid assembly according to claim 3, wherein the inner stopper comprises a first bottom disc and a circle of first sidewall extending along an axial direction at a periphery of the first bottom disc; and the inner lid comprises a second bottom disc and a circle of second sidewall extending along the axial direction at a periphery of the second bottom disc.

12. The packaging container according to claim 9, wherein in the sealing lid assembly, a limit mechanism is provided between the inner stopper and the inner lid; when the inner lid is rotated relative to the inner stopper, the limit mechanism is configured to limit the inner lid at a first position and a second position of the inner stopper; when the inner lid is located at the first position of the inner stopper, the discharge groove is located on the discharge region and communicates with the discharge hole, and the sealing member covers the discharge region; and when the inner lid is located at the second position of the inner stopper, the sealing region covers the discharge region to seal the discharge hole.

13. The packaging container according to claim 12, wherein in the sealing lid assembly, a puller is fixedly provided on an upper surface of the sealing member; a protrusion is provided on a lower surface of the sealing member and extends downwardly; and the protrusion is configured to be inserted into the discharge hole to seal the discharge hole.

14. The packaging container according to claim 12, wherein in the sealing lid assembly, the inner stopper comprises a first bottom disc and a circle of first sidewall extending along an axial direction at a periphery of the first bottom disc; and the inner lid comprises a second bottom disc and a circle of second sidewall extending along the axial direction at a periphery of the second bottom disc.

15. The packaging container according to claim 14, wherein in the sealing lid assembly, each of the first bottom disc and the second bottom disc is a circular structure; a diameter of the first bottom disc is greater than a diameter of the second bottom disc; the discharge region is located on the first bottom disc; and the sealing region, the discharge groove and the sealing member are located on the second bottom disc.

16. The packaging container according to claim 14, wherein in the sealing lid assembly, the rotary mechanism comprises a rotation hole and a rotating shaft; the rotation hole is formed at a central position of the first bottom disc, and the rotating shaft is provided at a central position of the second bottom disc; or the rotation hole is formed at the central position of the second bottom disc, and the rotating shaft is provided at the central position of the first bottom disc; and the rotating shaft is inserted into the rotation hole during assembly.

17. The packaging container according to claim 14, wherein in the sealing lid assembly, the limit mechanism comprises a guide post and a guide groove; during assembly, the guide post is provided in the guide groove and the guide post is configure to slide in the guide groove; the guide post is provided on the first bottom disc, and the guide groove is formed in the second bottom disc; or the guide post is provided on the second bottom disc, and the guide groove is formed in the first bottom disc; and the guide groove is a circular arc-shaped structure, and the guide groove is coaxial with the first bottom disc or the second bottom disc.

18. The packaging container according to claim 14, wherein in the sealing lid assembly, the limit mechanism comprises a guide post and a guide groove; during assembly, the guide post is provided in the guide groove and the guide post is configure to slide in the guide groove; the guide post is provided on the circle of first sidewall, and the guide groove is formed in the circle of second sidewall; or the guide post is provided on the circle of second sidewall, and the guide groove is formed in the circle of first sidewall; and the guide groove is a circular arc-shaped structure, and the guide groove is coaxial with the first bottom disc or the second bottom disc.
